(19) United States
(12) Patent Application Publication
(10) Pub. No.: US 2005/0157939 A1
(43) Pub. Date: Jul. 21, 2005

(54) Processes, products and systems for enhancing images of blood vessels

(76) Inventors: Mark Arsenault, Sanford, ME (US); Dominic Pelletier, Raymond, ME (US); Ronald Marcotte, New Gloucester, ME (US); Daren Hebold, Freeport, ME (US)

Correspondence Address: Lawson & Persson, P.C., Suite 103, 67 Water Street, Laconia, NH, 03246, US

(21) Appl. No.: 10/760,051

(22) Filed: Jan. 16, 2004

(51) Int. Cl. G06K 9/00; G06K 9/40

(52) U.S. Cl. 382/260; 382/128

(57) ABSTRACT

Processes, program products, and systems for enhancing images. The process includes the steps of padding image data to produce padded image data, transforming the padded image data to produce transformed image data, smoothing a substantial portion of the transformed image data, re-transforming the transformed image data to produce smoothed image data, inverting the smoothed image data to generate inverted image data, and adding the inverted image data to unenhanced image data to generate a result image

### FIELD OF THE INVENTION

The present invention relates to the field of enhancing the quality of an image, and in particular to enhancing a raw image obtained from chromatic light-aided examination of blood vessels.

### BACKGROUND OF THE INVENTION

Venepuncture, the procedure of entering a vein with a needle, is one of the most commonly performed invasive procedures. Locating a vein can be difficult, and there is also a risk that the needle will overshoot once it has been inserted under the skin. Healthcare providers are often not sure that they have entered the vein until the needle is in. Occasionally, this leads to a certain amount of painful probing with patients having to endure the discomfort of a needle being pushed in and out several times. The unfortunate patient that encounters this probing will be understandably reticent about receiving future injections—sometimes to the point of causing vasoconstriction in future venepuncture attempts. Accurately finding a vein is not merely a problem of discomfort; complications due to obesity, infancy, advanced age, skin complexion, obstructions such as blood or dirt, or inadequate/makeshift medical surroundings may hinder locating a vein, which might create medically perilous situations.

Numerous and accessible, the superficial veins of the upper limb are most commonly chosen for venepuncture in order to maximize safety and minimize discomfort. The veins often used for venepuncture are those found in the antecubital fossa, because they are sizeable veins capable of providing copious and repeated blood specimens. However, the venous anatomy of each individual may differ. The main veins of choice are the median cubital veins, the cephalic vein and the basilic vein.

The median cubital vein is not always visible. It is unfortunate that the median cubital vein is often not visible, as this vein is well supported by subcutaneous tissue and will not roll under needle pressure, making it an excellent candidate for venepuncture. In a well-equipped setting with a medically sound patient, this is not a major problem, as the size and location of this vein often makes it easy to palpate. However, palpation carries its own set of problems.

Palpation is a common assessment technique. Palpation helps determine the location and condition of the vein, assists in distinguishing veins from arteries and tendons, identifies the presence of valves, and detects deeper veins. Unfortunately, palpation requires vein-locating personnel to examine the patient with fingers, which may mislead medical personnel due to the various negative factors with which the examiner must contend. One such factor is that all patients are unique and the skin of one patient may be unlike that of another. Furthermore, palpation works best when the veins are on the surface. It is also harder to find veins on the obese using palpation. Moreover, palpation is best performed on a clean patient free from obstructions such as blood, dirt, etc. An additional negative factor is that the fingertips must be adequately sensitized to the process. This elevates palpation to an art form best practiced by the experienced. Indeed, the typical member of the medical profession—as s/he was probably advised in the early stages of their career—typically uses the same fingers in each examination so as to increase the sensitivity and ability to know what s/he is feeling. Moreover, s/he was probably further advised to never use the thumb in examination; having a pulse, it is the least sensitive and may lead to confusion in distinguishing veins from arteries in the patient.

The cephalic vein, a second option among many, rises from the dorsal veins and flows upwards along the radial border of the forearm, crossing the antecubital fossa as the median cephalic vein. Care must be taken to avoid accidental arterial puncture, as this vein crosses the brachial artery. Furthermore, it is in close proximity to the radial nerve. A vein that is bordered by an artery and a nerve, such as this, demands only accurate venepuncture in order to avoid damage to sensitive areas.

In reality, all procedures involving blood vessels require accuracy because blood is the primary means of transport within the human body. The harm of a damaged blood vessel is not simply relegated to the blood vessel, but it instead adversely affects every cell dependent upon it. In particular, veins that are repeatedly jabbed can become inflamed or close up. In an ideal scenario, medical personnel would be able to locate a vein quickly and have that vein contrasted With respect to surrounding tissue to allow accurate vein access.

As of late, apparatus have developed that help medical personnel more accurately identify blood vessels. Specifically, U.S. Pat. No. 5,519,208, issued May, 21, 1998 purportedly describes a method and apparatus for gaining intravenous access that includes a source of radiation for irradiating an area of the patient with radiation having a wavelength that is absorbed in areas containing veins and reflected in all other areas. The reflected radiation is then read and the output displayed. Using this technique, venous structures appear as dark lines on the display, enabling a user to position the tip of a hypodermic needle at an appropriate location for drawing blood.

Along similar lines, U.S. Pat. No. 6,032,070, issued Feb. 29, 2000 purports to describe a system and method to view an anatomical structure such as a blood vessel in high contrast with its surrounding tissue. The system and method may be used to produce an image of an anatomical structure using reflected electromagnetic radiation singularly scattered from target tissue. The system and method purport to provide improved contrast between any anatomical structure and its surrounding tissue for use in any imaging system.

Likewise, U.S. Pat. No. 6,230,046, issued May 8, 2001 purportedly discloses a system and method for enhancing visualization of veins, arteries or other subcutaneous natural or foreign structures of the body and for facilitating intravenous insertion or extraction of fluids, medication or the like in the administration of medical treatment to human or animal subjects. The system and method include a light source for illuminating or transilluminating the corresponding portion of the body with light of a selected wavelengths and a low-level light detector such as night vision goggles, a photomultiplier tube, photodiode or charge coupled device for generating an image of the illuminated body portion, and optical filter(s) of selected spectral transmittance which can be located at the light source(s), detector ,or both.

The above referenced patents are illustrative of attempts to demarcate blood vessels from surrounding tissue. Among their faults exists a common thread: poor image quality. The systems and methods of the described patents are non-invasive and, most importantly, provide the near “real time” visualization of the image necessary for these devices to serve their practical purpose. However, because of the need to provide near “real time” images, these devices primarily, if not solely, depend on raw images of relatively poor quality for venepuncture accuracy. Therefore, there is a need for a device that will provide the near “real time” imaging of these devices while greatly improving the quality of the viewed image. Improve the image; improve the accuracy!

Methods do exist for improving image quality. One such attempt is described in U.S. Pat. No. 5;991,456 (“456”), issued Nov. 23, 1999. In its method for improving an image, the image is initially represented by digital data indexed to represent positions on a display. The digital data is indicative of an intensity value Iᵢ(x,y) for each position (x,y) in each i-th spectral band. The intensity value for each position in each i-th spectral band is adjusted to generate an adjusted intensity value for each position in each i-th spectral band in accordance with:

$${\sum }_{n = 1}^{N} {W}_{n} ( log {I}_{i} ( x , y ) - log [ {I}_{i} ( x , y ) * {F}_{n} ( x , y ) ] ) , i = 1 , … , S$$

where ‘S’ is the number of unique spectral bands included in said digital data, Wₙ is a weighting factor and ‘*’ denotes the convolution operator. Each surround function Fₙ(x,y) is uniquely scaled to improve an aspect of the image, e.g., dynamic range compression, color constancy, and lightness rendition. The adjusted intensity value for each position in each i-th spectral band is filtered with a common function and then presented to a display device. For color images, a novel color restoration step is added to give the image true-to-life color that closely matches human observation.

Unfortunately the '456 patent is limited to still-frame image enhancement on a personal computer. Further, the time required to process the image data and produce the enhanced image is far too great to provide the near “real time” viewing of the enhanced images that is necessary for its use in improving the images produced by the devices described above. This same processing time limitation was found in all commercially available image enhancement programs, and was a major stumbling block to the development of the present invention.

Therefore, there is a need for a system that may be used to locate a blood vessel during venepuncture, that has the vein enhancing features of the prior art devices discussed above, but produces high quality images in near “real time” such that the system may be used by medical personnel during venepuncture.

### SUMMARY OF THE INVENTION

Creative uses of light yield images featuring blood vessels, but the usefulness of such images is limited by their quality. In particular, images of veins obtained from infrared wave emitters are of poor quality. It was clear that those in the medical field were close to a good solution to a prevalent problem. In an application assembled from so many fields of technology, from where would the next step toward usefulness come: general physics, spectroscopy, electronics, medicine, perhaps chemistry? Instead, the present invention opts to add yet another field of science to the present field, computer science.

It began with the unenhanced image; a poorly focused image with accentuated veins somewhere therein. The solution of image enhancement presented itself. Image enhancement is a common field; it should be applied to venepuncture, or so the present inventors first thought. The first investigation into program enhancement lay in the process of unsharp masking and two-dimensional filtration techniques, which had recently been applied to real-time video images to enhance the visualization of subtle features otherwise obscured by large dynamic range variations in background scenery. This first process, proposed by T. Peli and J. S. Lim, “Adaptive filtering for Image Enhancement,” Proc. ICASSP81, pp. 1117-1120, March 1981, and exemplified in the article by Ichiro Kuroda, Adaptive Image Enhancement Algorithms and Their Implementation for Real-Time Video Signals, ” IEICE Trans. Fundamentals, vol.E84-A, no.2, pp.390-399, Feb. 2001, worked well, but not well enough.

In order to discern the reasons that the first process worked, the inventors utilized alternate programs having characteristics similar to the components of the Kuroda process. The first such alternate program was the ADOBE PHOTOSHOP® Unsharp Filter. Using a kernel radius from 10 to 23, the program would Gaussian Blur an image, subtract that image from the original image and then level adjust the resulting image. The results of the ADOBE PHOTOSHOP® Unsharp Filter were comparable if not better than the Kuroda process. Unfortunately, the ADOBE®, filter was limited to still frame enhancement on a personal computer. It was decided to diverge from the method of simply experimenting with components of the Kuroda process in order to improve it. Instead, the new focus was to develop an original process with improved results.

The TI 6711 IDK platform as sold by Texas Instruments of Dallas Tex., having an NTSC input and VGA output, was next used to explore small kernel time-domain convolution sharpening. The algorithm comprised a two-step enhancement process: (1) a 3 by 3 spatial domain convolution and (2) Gamma LUT contrast enhancement. The IDK platform produced results ranging from not as good to worse than the Kuroda process, and undesired amplifications of noise and small features were often present. The IDK platform did produce moving pictures, albeit having an annoyingly noticeable lag-time of 130 milliseconds to 160 milliseconds. This platform had useful attributes and non-useful attributes, but was convenient in proving that substantial image-processing could be achieved in near real-time fashion.

During the course of the experimentation, RETINEX™, a PC based application of the TRUVIEW PHOTFLAIR® NASA algorithm purported to be covered by U.S. Pat. No. 5,991,456, was discovered. The grayscale processing of this application was an attractive attribute, but the color correction algorithm added excess processing time, limiting its applicability to still-frame enhancement. Despite this limitation, it was decided that any original process should have at least the clarity of images enhanced using RETINEX™.

Next, ADOBE PHOTOSHOP® was used to identify the relevant processing block required to produce the RETNEX™ level of grayscale image contrast enhancement, without the unnecessary color correction algorithm overhead. This identification uncovered a three-step process using elemental processing blocks: Gaussian Blurring a raw image with a kernel radius of 15, adding the inverse Gaussian-blurred image to the raw image, and level adjusting the result to use the entire dynamic range. The output was determined to be comparable to better than the RETINEX™ enhancement. Thus, work began to produce an original program producing substantially real-time images having results matching the aforementioned quality. After several failed attempts at an original program, the present invention was devised to achieve a better means for locating veins—although its applicability extends to any image.

The present invention includes a process for enhancing an image that is performed in a series of steps. These steps may be in the form of a computer program product that performs them using a microprocessor, through hardware integrated into a printed circuit board, Or through a combination of the two. One basic embodiment includes the steps of saving an unenhanced copy of the image data; transforming the image data to produce transformed image data; smoothing a substantial portion of the transformed image data; re-transforming the transformed image data to produce smoothed image data, inverting the smoothed image data to generate inverted image data, and adding the inverted image data to the, unenhanced copy of the image data to generate a result image. These steps are intended to be performed on an image to improve the image quality at a speed that allows the resulting images to be displayed in near real-time, although they are equally applicable to still images as well.

The preferred smoothing step utilizes the filtering method known in the art as blurring. Blurring smoothes transformed image data to produce smoothed image data. It is preferred the blurring be accomplished by Gaussian blurring in the frequency domain. However, it is recognized that the enhancement of the present invention need not use Gaussian blurring, or occur in the frequency domain at all, as spatial domain filters work, albeit at a slower speed. It is also recognized that the enhancement of the present invention could be performed using advanced transforms such as, but not limited to, the wavelet transform.

The blurring step preferably manipulates image quality with the aid of a suitable kernel. For such reasons, the present invention further preferably includes the step of initializing a kernel. Initializing a kernel is preferably accomplished by generating an effectively-dimensioned kernel array, padding the effectively-dimensioned kernel array to produce an effectively-dimensioned padded kernel array, and transforming the effectively padded kernel array.

The choice of kernel size creates a processing struggle between image quality and enhancement speed. It is found that an effectively-dimensioned kernel for purposes of enhancing subcutaneous images, such as veins, have a base radius of approximately 51. Preferred versions of the present invention use more than a basic kernel array, and the preferred kernel is padded to dimensions each having a power of two (i.e. 256 by 256, 1024 by 512, etc.). It is found that the most effectively dimensioned kernel array is sized to 1024 by 512 pixels with a black border, for a 640×480 image padded to 1024 by 512 pixels. However, unpadded images, or images padded to different dimensions, are contemplated and the invention should not be so limited.

The preferred method includes a padding step, which involves padding image data to produce padded image data sized to 1024 by 512 pixels. Alhough the present invention primarily uses 1024 by 512 pixel images, images having dimensions of a power of 2 are beneficial for the preferred type of Fast Fourier Transform (FFT) algorithm. Regardless of the size—which need not be either 1024 by 512 or sized to a power of 2—it is preferred that the padded image data be sized similarly to the padded kernel, typically with both sized to the exact same dimensions.

The image enhancing process may include additional steps. For example, it is useful for the process to include contrast stretching of the result image to include a substantially full range of pixel values. The result of contrast stretching is a stretched image. Contrast stretching beneficially provides a greater range of grayscale values based upon data obtained from the result image. It is preferred that, in a process using an 8-bit instrumentation, the full range of grayscale values includes values beginning with 0 and ending at 255—though not all values between 0 and 255 require presence. The contrast-stretching step is preferably performed after the adding step.

Some embodiments of the process also include the step of applying an effective gamma curve to the result image. The gamma correction curve is a nonlinear image adjustment curve, the shape of which depends on the image characteristics and the video monitor used for display of the image. The outcome of applying an effective gamma curve is to generate an image corrected for the lightness sensitivity of vision. Therefore, in embodiments of the process where this step is performed, it is preferred that this step be performed after the contrast stretching step.

Another image enhancing process step involves converting an analog image to an effectively-dimensioned image array. This step is used in non-preferred embodiments where a camera produces analog images instead of the images produced by the preferred CMOS camera. As much of the process steps require the presence of an image, it is preferred that the converting step occur prior to the performing any of the other steps. It is further preferred that the converting step conclude by presenting an 8-bit grayscale image array, preferably in an array having the dimensions of 640 by 480 pixels. However, in alternative embodiments, the converting step may present a 10-bit grayscale image array of 640 by 480 pixels.

The present invention further includes a computer program product for enhancing an image. One basic version of the computer program product performs the steps set forth above in connection with the process of the present invention using various program structures. These program structures include a digital transformer for transforming unenhanced image data to produce transformed image data, a smoothing operator for smoothing a substantial portion of the transformed image data, a digital re-transformer for re-transforming the image data to produce spacial domain smoothed image data; a digital inverter for inverting the smoothed image data to generate inverted image data, and an adding function for adding to a copy of the unenhanced image data to the inverted image data to generate a result image.

The preferred smoothing operator of the computer program product uses 2-D Gaussian-blurring means that includes a kernel generator for generating an effectively-dimensioned kernel array, a kernel padding operator for padding the effectively-dimensioned kernel array to produce an effectively-dimensioned padded kernel array, and a kernel transforming operator for transforming the effectively padded kernel array. Effective dimensions for kernels and their derivatives is meant to be a size dimension amenable to a computer processor of the time period and capable of meaningful image enhancement. A preferred kernel is one having been generated from a kernel radius of approximately 15. A preferred effectively-dimensioned padded kernel array is one padded to a size with a height having a power of two and a width having a power of two; and even more preferably having the padded dimensions of 1024 by 512 pixels. The preferred padding border is black. The size of the image features that are enhanced is controlled by the shape of the 2 dimensional Gaussian-blur kernel. Kernel radii in the range of approximately 10-23 pixels best enhance the blood vessels of interest in this application. The kernel radius parameter specifies the standard deviation (σ) of the Gaussian blur kernel. The 2-dimensional blur array values are generated from:

$$V ( x , y ) = \frac{{ⅇ}^{- ( {x}^{2} * {y}^{2} )}}{2 * {σ}^{2}}$$

where: V_{(x y)} is the value of Gaussian at each x,y coordinate in the matrix,

e is the natural constant approximated by 2.7182818284 . . . ,

and σ is the desired standard deviation of the Gaussian function.

Once generated, the values are quantized to integer values and normalized to the dynamic range used in the computer program.

The base, or dimensions of the kernel array, is directly related to the standard deviation used to generate the kernel. For a Gaussian distribution, 2/3 of the area under the distribution lies between −σ and σ. The size of the kernel base is a tradeoff between accuracy and processing speed. The preferred kernel base is 105×105 pixels for a standard deviation of 15, which is approximately +/−3.5 σ.

Additional embodiments of the computer program product may utilize extra elements. One such element is a contrast stretcher for stretching the result image to include a substantially full range of pixel values to generate a stretched image. The contrast stretcher performs the contrast stretching step of the process of the present invention.

Additional embodiments may further employ gamma correction. The gamma correction employs the gamma-correcting step of the process, and it may be applied in conjunction with either the contrast stretcher or the adding function. The output of the gamma correction is a gamma corrected image.

Other embodiments may further utilize an analog-to-digital converter. The analog-to-digital converter of the computer program product performs the steps for converting an analog image to an effectively-dimensioned image array. The preferred output is an 8-bit grayscale image array; preferably sized to 640 by 480 pixels. Alternatively, a 10-bit output having a 640 by 480 pixel array may also be utilized.

The present invention further includes an image display system. The digital display system includes the computer program product for enhancing an image and a display device equipped to display an output of the computer program product. The display device may include a television monitor, computer monitor, an LCD monitor, or any other art recognized means for displaying a pixel-based image. The display system, preferred in the vein viewing embodiment, may additionally use a headset bearing the display device in a manner that allows a line of sight of a user to focus on images exhibited by the display device. The vein-viewing embodiment further comprises additional detection equipment. The preferred detection assembly has an infrared emitter configured to illuminate a portion of skin; and an infrared detector, equipped to pass a signal to the computer program product and configured to accept infrared emissions reflected from the skin. The preferred infrared emitter is one or more light emitting diodes and the preferred infrared detector is a CMOS receptor. Additional features of the vein viewing embodiment include cross polarizers placed in the path of the light to cross-polarize infrared emissions reflected from the skin. ‘Vein-viewing’ is not meant to assert that that particular embodiment adapted to singly enhance an images veins, it is instead illustrative of the preferred use of that particular embodiment and may be used to view anything (corporeal or not) that is capable of enhancement with the computer program product.

Preferred embodiments of the display system include a computing unit adapted to execute the computer program product. The computer program product is preferably performed with any processor known in the art. Other embodiments based thereon have output means from the computing unit to the display device. The output means might comprise an S-video output or some other art recognized means for signal relay.

Therefore, it is an aspect of the present invention to apply image enhancement to images showing blood vessel location.

It is a further aspect of the present invention to provide an improved image of human body components that is free from the image deterioration that accompanies typical analog-to-digital conversions.

It is a still further aspect of the present invention to provide a substantially real-time digital visualization of human body components.

It is a still further aspect of the present invention to provide a convenient, portable vein viewer.

It is a still further aspect of the present invention to provide a reliably accurate vein viewer.

These aspects of the invention are not meant to be exclusive and other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 is a flowchart describing the steps of the basic process for enhancing an image of the present invention.

FIG. 2 is a flowchart describing the process performed during the operation of the preferred embodiment of the computer program product of the present invention.

FIG. 3 is a flowchart describing the process performed during the operation of a program cycle of the preferred embodiment of the computer program product of the present invention.

FIG. 4 is a front isometric view of the preferred embodiment of the system of the present invention.

FIG. 5 is a rear isometric view of the preferred embodiment of the system of the present invention.

FIG. 6A is an image of a human forearm showing unpolarized visible spectrum light reflected from the forearm and captured by a camera.

FIG. 6B is a raw image of the human forearm of FIG. 6A showing cross-polarized infrared spectrum light reflected from the forearm and captured by the CMOS camera of the preferred system of the present invention.

FIG. 6C is an enhanced image resulting from the operation of the computer program product of the present invention on the raw image of the human forearm of FIG. 6B.

### DETAILED DESCRIPTION OF THE INVENTION

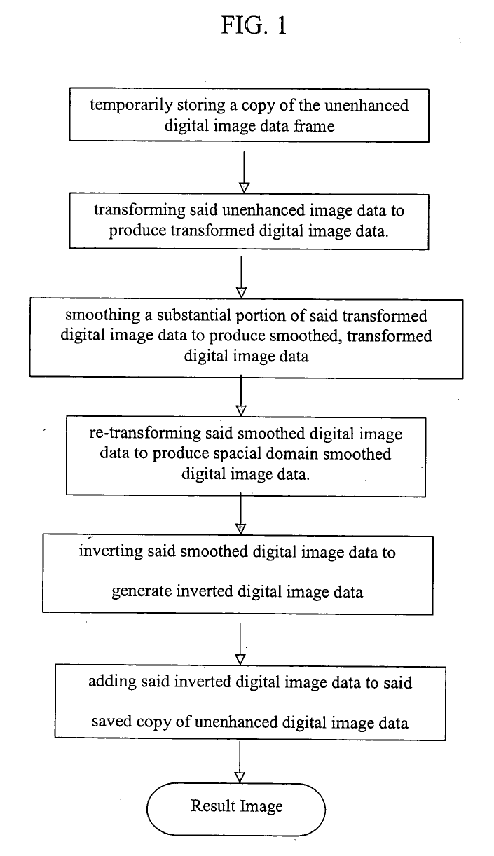

As described with reference to FIG. 1, the process of the present invention is performed in a series of steps, which result in the enhancement of the image produced. Steps of a basic embodiment include saving a copy of unenhanced image data, transforming the copy of the unenhanced image data to produce transformed image data; smoothing a substantial portion of the transformed image data to produce smoothed transformed image data in the frequency domain; retransforming smoothed, transformed, image data to produce a smoothed image in the spacial domain; inverting the smoothed image data to generate inverted image data; and adding the inverted image data to an unenhanced copy of the image data to generate a result image. These steps are intended to be performed on an image to improve the image quality at a speed that allows the resulting images to be displayed in near real-time.

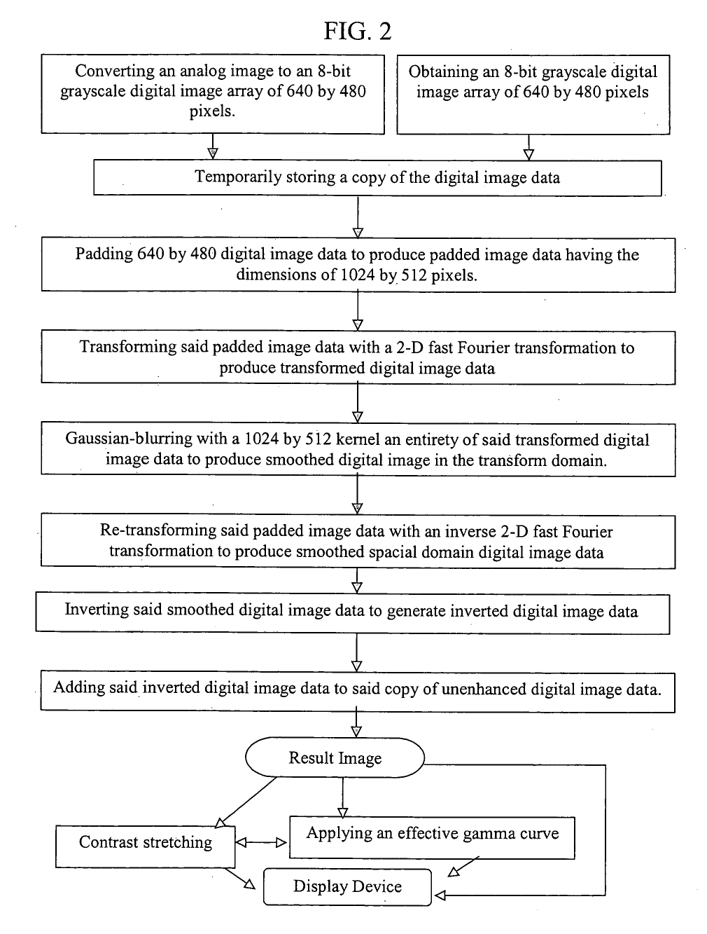

In order to fully describe the process, it is useful to look to its preferred implementation; as a computer program product to be run on a personal computer, headset system computing unit, or other microprocessor based apparatus. As described with reference to FIG. 2, the computer program product of the present invention is preferably made up of multiple program routines. The preferred program product includes converting means, blurring means, initializing means, padding means, Fourier transform means, inverting means, adding means, and contrast-stretching means. The converting means acts to convert the digital data to a raw image. The blurring means blurs the raw image to create a blurred image. Initializing means initializes a kernel having acceptable dimensions. Padding means pads the raw image to create a padded image having row and column dimensions that are powers of 2. Fourier-transforming means then fast-Fourier transforms the padded image, in the spacial domain, to a complex image of real and imaginary parts in the frequency domain. Re-transforming means then inverse fast-Fourier transforms the padded image, in the frequency domain, back to the spacial domain. Inverting means inverts the blurred image to create an inverted blurred image. Adding means adds the inverted blurred image to a copy of the unenhanced image data to create a resulting image. Contrast-stretching means contrast-stretches the resulting image.

Images obtained from infrared skin-reflections are of typically poor quality when received by a CMOS receptor. When dealing when blood vessels, it is important to have accurate, clear images of internal components. The converting means is a preliminary step of the program means of the present invention that enhances the data received from the CMOS receptor. The converting means of the present invention serves to translate digital data to raw image data. From the digital data, for example, the preferred converting means generates a 640×480 grayscale pixel array; that is, the only colors are shades of gray. Gray images are preferred because less information needs to be provided for each pixel. The ‘gray’ color of the grayscale pixel array occurs because the CMOS receptor is monochromatic. Grayscale images allow a program to specify a single intensity value for each pixel, as opposed to the three intensities needed to specify each pixel in a full color image.

The preferred grayscale intensity is stored as an 8-bit integer—giving a total of 256 shades of gray between the extremes: white and black. Grayscale images are sufficient for the clarity required in present invention and processing color images would be needlessly cumbersome on a computing unit.

The blurring means blurs the raw image to create a blurred image. The preferred blurring means performs Gaussian-blurring, or Gaussian-smoothing as it is sometimes called, which is a 2-D convolution operator that “blurs” images to remove unwanted detail and noise. This convolution is a simple mathematical operation that multiplies together two arrays of numbers, of different sizes, but of the same dimensionality, to produce an output image comprising a third array of numbers of the same dimensionality. For example, some embodiments of the present invention utilize the transformed image grayscale pixel array as a first array of cells, and a transformed kernel as the second array of cells. The convolution is performed by multiplying together the kernel value and the underlying image pixel value for each of the cells in the kernel and then scaling the result.

As noted above, the preferred blurring means is 2-D Gaussian smoothing means. Since the raw grayscale image comprises a collection of discrete pixels, the program means produces a discrete approximation to the Gaussian function before performing any convolution operations. Theoretically, a Gaussian distribution is non-zero everywhere, and thus a program would require an infinitely large convolution kernel. The preferred kernel of the present invention utilizes a 105×105 cell array having a standard deviation of 15. The chosen standard deviation of the Gaussian distribution determines the degree of blurring; larger standard deviation Gaussian distributions require larger convolution kernels in order to accurately represent the raw image. However, it should be noted that, in practice, a Gaussian distribution is effectively zero more than about three standard deviations from the mean. Truncating the kernel at such point would be acceptable, and some embodiments of the present invention optionally include means for allowing a user to adjust the dimensions of a kernel to take advantage of this possibility.

The 2-D Gaussian convolution can be performed by first convolving with a 1-D Gaussian in the x direction, and then convolving with another 1-D Gaussian in the y direction. Because a Gaussian convolution outputs a ‘weighted average’ of each pixel's neighborhood, with the average weighted more towards the value of the central pixels, a Gaussian convolution provides gentler smoothing and preserves edges better than many other similarly sized filters. A primary reason for using Gaussian blurring is its convenient frequency response. Most convolution-based smoothing filters act as lowpass frequency filters; that is they remove high spatial frequency components from an image. The output of the blurring step is a pixel array. However, although Gaussian blurring or smoothing is preferred, it is recognized that a variety of art recognized blurring means may be utilized. Accordingly, the blurring means should not be so limited to Gaussian blurring means.

The Fourier-transforming means of the present means utilizes a power of two 2-D fast-Fourier transformation upon a two-dimensional data array. The 2-D fast-Fourier transform originates from the continuous 2-D Fourier transform:
F(u,v)=∫∫f(x,y)exp(−2πi[ux+vy])dxdy
For a discrete array having dimensions M and N, the 2-D fast-Fourier transform is implemented by the equation:

$$F ( m , n ) = {\sum }_{l = - N / 2}^{( N / 2 ) - 1} {\sum }_{k = - M / 2}^{( M / 2 ) - 1} f ( k , l ) exp ( - 2 π i [ \frac{mk}{M + nl} \div N ] )$$

The inverse 2-D fast-Fourier transform is implemented by the equation:

$$f ( m , n ) = \frac{1}{MN} {\sum }_{l = - N / 2}^{( N / 2 ) - 1} f ( k , l ) exp ( - 2 π i [ \frac{mk}{M + nl} \div N ] )$$

These transforms utilize fixed-point double precision arithmetic with an optimized assembly FFT provided in the Texas Instruments DSP program library. In this calculation, the factor of (1/MN) is used in the inverse FFTcalculation and takes advantage of a property whereby the inverse transform result is arrived at by performing the forward transform on sequences of the complex data that have swapped real and imaginary parts. However, other variations would be immediately apparent to one skilled in the art of image processing. For example, it is noted that the transformations can be defined in a more systematic fashion be using a normalization constant of

$$\frac{1}{\sqrt{MN}} ,$$

and a value range of

$$- \frac{N}{2} \leq n < \frac{N}{2} and - \frac{M}{2} \leq m < \frac{M}{2} .$$

The padding of the present invention adds a border of a specified size and color to the edges of an image. The preferred program means performs at least one padding operation per cycle. The original raw image, having dimensions of 640×480, is padded to 1024×512. The surrounding padding is at gray level 128. Additionally, the preferred kernel of the present invention is padded with a black border to 1024×512. The padding shade and sizes represent preferred embodiments and not the exclusive means of achieving the aspects of the present invention.

Contrast stretching is optionally applied to an image of the present invention. Contrast stretching stretches a histogram to fill the full dynamic range of the image. This is a useful technique to enhance images that have low contrast and works best with images that have a Gaussian, or near-Gaussian, distribution. Simple contrast stretching works well on images that have all pixels concentrated in one part of the histogram, the middle, for example. The contrast stretch expands the image histogram to cover all, or substantially all, pixel ranges. The highest and lowest value pixels are used to calculate new histogram boundaries. To generate the new pixel value based on a histogram of an image having a high pixel boundary, ω, and a low pixel boundary, α, simply follow the equation below.

$$new\_pixel = \frac{old\_pixel - α}{ω - α}$$

Following this equation will generate a transformed image that more completely fills the histogram space to take advantage of a more complete range of pixel values, for example 0 to 255. However, the inventor is aware of other forms of contrast stretching, ‘ends-in-search’ stretching for example, and does not intend to limit the invention to a single form of contrast stretching.

Contrast stretching algorithms are preferably implemented with the aid of a look-up-table (“LUT”). LUTs are simply arrays that use the current pixel value as the array index. The new value is the array element corresponding to the current pixel value marker. The new image is generated by repeating the process for each pixel of the array in no preferred direction. The prime advantage of LUTs is their computational efficiency. The preferred version of the present invention utilizes 8-bit images, thus only the processor need only compute 256 values regardless of image size. There is no bounds-checking on the value returned from operation: values greater than 255 will be set to 255; values less than 0 will be set to 0. It is preferred that the contrast stretching algorithm be specified as a constant LUT, but a digital selector may be utilized to select different high and low pixel boundaries. If a user desires different contrast stretching the digital selector may be utilized to select different high and low pixel boundaries which in turn causes the calculation of a new LUT for contrast stretching. In practice, the selector has a variability that allows the user to fine tune the contrast stretching to compensate for ambient lighting conditions and other variables that may degrade optimal contrast.

The brightness of an image of the present invention can be adjusted with a gamma correction transformation. The general form for gamma correction is: output=input^{1/x}. If x=1.0, the result is null transform. If 0<x<1.0, then the x creates exponential curves that dim an image. If x>1.0, then the result is logarithmic curves that brighten an image. Contrast stretching is an intensity transformation. It is preferred that the gamma correction curve be specified as a constant LUT, but a digital selector may be utilized to select a different gamma correction x factor. If a user desires different gamma correction the digital selector may be utilized to select a different gamma which in turn causes the calculation of a new LUT for gamma correction. In practice, the selector has a variability that allows the user to fine tune the gamma correction to compensate for ambient lighting conditions, display characteristics, image background and other variables that may degrade optimal contrast.

Intensity transformation is a point process that converts an old pixel into a new pixel based on some predefined function. These transformations are easily implemented with simple look-up tables. An example of a LUT for inverting an 8-bit grayscale image is shown in Table 1. However, it is recognized that a number of different LUTs could be used.

TABLE 1
Example LUT for inverting an 8-bit Grayscale Image

| Original Pixel Value | New Pixel Value |
|---|---|
| 0 | 255 |
| (Black) | (White) |
| 1 | 254 |
| 2 | 253 |
| . | . |
| . | . |
| . | . |
| 252 | 3 |
| 253 | 2 |
| 254 | 1 |
| 255 | 0 |
| (White) | (Black) |

### EXAMPLE OF A PREFERRED PROGRAM CYCLE

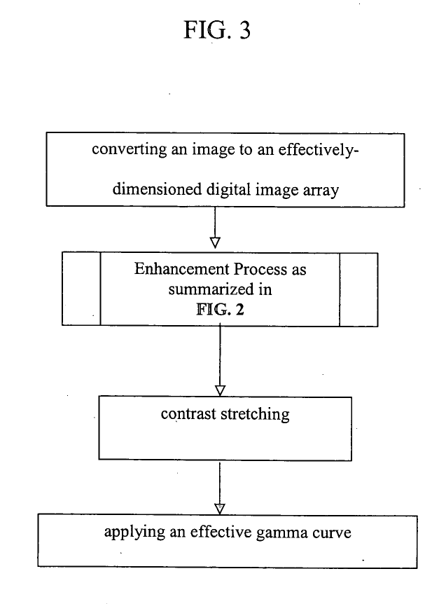

To help teach the present invention, it is illustrative to run though a preferred program cycle, which is described herein with reference to FIG. 3. Program cycle is meant to be actions that the program means performs upon a single image obtained from an input source. The numbers, colors, mathematical data, equations, and the like of this example represent preferred embodiments.

Because the present invention enhances images, an image must first be accessible. There are two contemplated paths to access the image. A first path includes simply inputting an image. A second path includes obtaining an analog image and then converting that analog image into an image. The first path is preferred over the second merely because of program efficiency; it requires less processing time to simply input an image than to convert an analog image to an image. Whether an analog-to-digital converter appears in the present invention depends chiefly upon the images communicated to the program.

The padder of the present invention pads image data received to produce padded image data. Initially the digital padder inputs an array of image data. The preferred input is a 640 by 480 grayscale pixel array. The input may be any image array, yet the preferred input will be explained in this description for exemplary purposes. The image data array is then padded to an effective size. An effective size is determined by the size of the array, which is determinative of the processing time required to manipulate the data at a later point in the program cycle. As padding an image prepares that image for a later transforming step, size effectiveness is also determined by the dimensions of the kernel used in the later transformation step: kernel size and digital padded image size should be compatible (usually equal). A preferred padded image data array is sized to a power of two; that is, both the height and width of the array include 2, 4, 8, 16, 32, 64, 128, etc. pixel values. An even more preferred padded image data array size is sized to 1024 by 512. Thus, the previously mentioned 640 by 480 grayscale pixel array, would be surrounded with a suitable border of color values until the dimensions of 1024 by 512 are reached. When using 8-bit grayscale, as is preferred, the preferred padding is at gray level 128. This 128 value represents a mid-gray intensity that minimizes edge effects resulting from the discrete transform process. After padding the image data, the padded image data is then preferably sent to a digital transformer.

The digital transformer of the present invention comprises means for transforming the padded image to produce transformed image data. The preferred digital transformer performs a two-dimensional fast Fourier transformation (2-D FFT) on the padded image data—though it is recognized that two one-dimensional transformations would frequently suffice. After transforming the padded image data, the transformed image data is sent to a smoothing operator.

The smoothing operator of the present invention comprises means for smoothing a substantial portion of the transformed image to produce smoothed image data. The preferred smoothing operator performs a two-dimensional Gaussian blur upon the substantial portion of the transformed image data. A substantial portion is a portion of the input image that contains details that are desired to be enhanced. A substantial portion might be the entire content of an image, or a section in the interior of the image.

Though smoothing convolutions can be calculated in either the frequency domain or the spatial domain, the frequency convolution is preferred. In operation, the preferred smoothing operator manipulates an input array, here the transformed image, with a second array. The second array is also two-dimensional, has the same dimensions as the image, and is known as the transformed kernel. The preferred transformed kernel is a two-dimensional frequency domain array. The transformed kernel is derived from a 2-D Gaussian spacial domain kernel having a preferred standard deviation of 15 and base radius of 51, i.e. 105 by 105 array.

In the preferred smoothing operation, the elements of the inputted transformed image data array are multiplied by the corresponding transformed kernel elements. Each resulting position corresponds to a single pixel of the blurred image in the frequency domain.

When performing the frequency convolution preferred embodiment, a transformed kernel must be initialized. A transformed kernel is preferably initialized in the steps of generating an effectively-dimensioned time-domain kernel array, padding the effectively-dimensioned kernel array to produce an effectively-dimensioned padded kernel array, and transforming the effectively padded kernel array.

A preferred version of present invention utilizes a kernel generator to produce an effectively-dimensioned transformed kernel array. The kernel generator preferably originates a kernel sized to dimensions suitable for a later 2-D Gaussian blur. The preferred time-domain kernel has standard deviation of 15 and base radius of 51, i.e. 105 by 105 array. Kernels with other standard deviations in the range of 10 to 23 are often suitable for many program applications. In general, standard deviations closer to the low end of the range are more suitable for enhancing smaller features. Standard deviations closer to the upper end of the range are more suited to enhancing larger features, for example larger veins. Kernels derived from 2-D Gaussians of greater standard deviation require a correspondingly larger base radius. After generating an effectively dimensioned kernel array, the effectively dimensioned kernel array is then sent to a kernel padding operator.

A preferred version of the present invention utilizes a kernel padder operator that produces an effectively padded kernel array from the effectively dimensioned kernel array. An effective size is primarily determined by the size of the input transformed image that the kernel will later filter in the later smoothing operator. The preferred operator pads the kernel with a border equal to the known size of the padded image data with which the kernel later convolves; other effective padded kernel sizes include sizes approximately equal to the known size of the padded image data with which the kernel with later convolve. Another implementation would use a kernel of smaller size than the padded image. This would require a different method in performing the frequency domain convolution.

As the preferred padded image data array size is sized to be 1024 by 512, the preferred padded kernel is similarly 1024 by 512. Preferred values for border material are zero's, which effectively represents the Gaussian as zero outside of it computed kernel radius. After padding the effectively dimensioned kernel array to produce an effectively padded kernel, then that effectively padded kernel array is transformed.

The preferred version of the present invention further includes a kernel transforming operator for transforming the effectively padded kernel array. The preferred kernel transforming operator of the present invention includes means for transforming the effectively padded kernel to produce an image compatible kernel. The preferred transforming operator performs a two-dimensional fast Fourier transformation (2-D FFT) on the padded kernel array—though it is recognized that two one-dimensional transformations would frequently suffice. The kernel is now set to convolve with an image of the present invention.

Although the preferred version of the present invention initializes a kernel, it is not considered to be essential that the kernel is initialized. Another approach would compute the transformed kernel separately, on another computer, and save the result in the DSP memory. The preferred method of initializing the kernel at the time of DSP power up allows a feature whereby the user can select from various kernels, depending upon the specific application. In this latter approach, many kernels can be stored in an unpadded, compressed, form to reduce memory requirements. Only the chosen kernel is padded to the image size.

After smoothing a substantial portion of the transformed image data to produce smoothed image data, the image data is re-transformed into the spatial domain utilizing a 2-D inverse fast Fourier transformation.

After re-transforming the smoothed image data into the spacial domain, the image data is sent to a digital inverter to generate inverted image data. After inverting the smoothed image data to generate inverted image data, the inverted image data is then preferably sent to an adding function for adding the padded image data to the inverted image data to generate a result image. The adding function operates to add two arrays together to produce a single resulting image. The first array to be added is a copy of the unenhanced image data; the second array to be added is the array having the inverted image data. The preferred method of adding the inverted, smoothed image data to the raw image data is such as to combine equal parts of each. A digital selector may be utilized to select a different ratio of the inverted, smoothed image data to be combined with the unenhanced image data. If a user desires a more natural appearing image, with less of the contrast enhancement the selector can be used to combine less of the inverted, smoothed image data with the unenhanced image data at the adding function. In practice, the selector has a variability that allows the user to fine tune the “strength” of the contrast enhancement to aid in determining whether an enhanced feature is, for example, a vein or a crease in the skin.

The resulting image is capable of viewing by convention image viewing means but often requires further enhancement.

The preferred program cycle of the preferred embodiment of the present invention includes a contrast stretcher for stretching the result image to include a substantially full range of pixel values to generate a stretched image. The contrast stretcher generates a stretched image by determining a high threshold value and a low threshold value of the result image. In the preferred 8-bit grayscale version of the present invention, there will be 256 possible pixel values. In such an embodiment, the contrast stretcher finds and recalculates the low threshold value to zero, finds and recalculates the high threshold value to 255 and proportions intermediate values (1-254) therebetween. Now the image exploits a greater range of values with greater contrast between the highest and lowest values. After the contrast stretcher, the stretched image is passed to a gamma correction unit.

The preferred program cycle of the preferred embodiment of the present invention further utilizes gamma correction to generate a gamma corrected image from the stretched image. It is, however, important to note that more basic embodiments lacking the contrast stretcher would simply apply gamma correction to the result image of the adding step. The gamma correction would be performed through the use of a look up table (LUT). Another embodiment of the present invention would combine the contrast stretch and gamma adjustment into the same LUT.

The following explanation of a preferred program cycle is purely illustrative. Program cycle is meant to be actions that the program means performs upon a single image obtained from an input source. Basic embodiments of the present invention include less steps and elements than were outlined in the preferred program cycle. The numbers, colors, mathematical data, equations, and the like of this example represented preferred embodiments. The inventors are aware of multitudinous other image sizes, colors, mathematical data, equations, and the like that are compatible with the present invention.

The program of the present invention may be run on any compatible processing unit. Compatible processing units are processors having a speed sufficient to calculate the program steps of the present invention at a speed that is approximately real-time. Real time is the absence of meaningful lag. Meaningful lag differs between embodiments of the present invention; embodiments simply running the program need not consider lag time to the degree of those embodiments displaying images from the program steps of the present invention. When viewing images though a display embodiment of the present invention, the absence of meaningful lag is defined as a rate of image display that allows a user to perform functions with the present invention that occur in real time. For example, if a physician can accurate place a needle upon a correct skin location that is viewed and enhanced through an embodiment of the present invention, then there is no meaningful lag.

The image display system embodiment of the present invention displays an image of the program. To accomplish image display, the present invention includes a display device adapted to exhibit an output of the program of the present invention. The output is any image taken from any step of the program. It is preferred that the output image is either the result image, or a later image deriving from the result image (for example the stretched image or gamma corrected image).

The display device of the present invention includes any electronic device having resolution capable of exhibiting 256 colors or better, which is sufficient to display the grayscale images produce by the system. A video monitor is a preferred display device due to universality, minimal expense, quality, and because a video monitor is often used in conjunction with programs anyway. Transferring data from the program to the display device may occur via any means known in the information sciences; the preferred means is use of an analog RGB, VGA video cable. Other preferred display means are used in conjunction with a portable vein viewing embodiment of the system.

Vein viewing embodiments, not necessarily portable versions, include a detection assembly having at least an infrared emitter and an infrared detector. The infrared emitter is a device emitting electromagnetic radiation between the frequency of radio waves and the visible spectrum. The preferred electromagnetic radiation is in the near-infrared range having a wavelength of 880 nanometers. Wavelengths in the range of 850 nm to 1050 nm have been determined to be particularly effective for enhancing veins. In operation, the infrared emitter acts to radiate an object with IR waves at a distance suitable to generate return waves. The preferred infrared detector acts to receive the radiation from the emitter that has reflected from an Object.

The vein viewing embodiments of the present invention may employ multiple infrared detectors. Pick-up tubes, CMOS (Complementary Metal Oxide Semiconductor) pickups and CCD (Charge Coupled Device) chips are all suitable, though CMOS pickups are preferred as they generate images, and thus, obviate the need for later analog-to-digital conversion. Color versions of CCD and CMOS image sensors are unsuitable as they generally are coated with dyes to facilitate capture of color information. This dye pattern, along with the IR blocking filters generally found in color sensors degrades the color device's sensitivity in the infrared wavelengths of interest. In operation, the infrared detector receives the radiation reflected from an object. That radiation is then translated into a series of pixel values in an image array. That image array is then sent to the program of the present invention for enhancement.

The vein viewing embodiment may further employ polarizing means configured to cross-polarize infrared emissions reflected from an object. The polarizing means preferably employs two polarizing lenses. A first filter is positioned between the path of the infrared emitter and the object. The first filter acts to filter the radiation passing therein into a single plane of polarization. After the polarized radiation contacts an object and reflects, a second filter separates the radiation into a second plane of polarization. To pick up skin details, it is preferred that the radiation be cross-polarized.

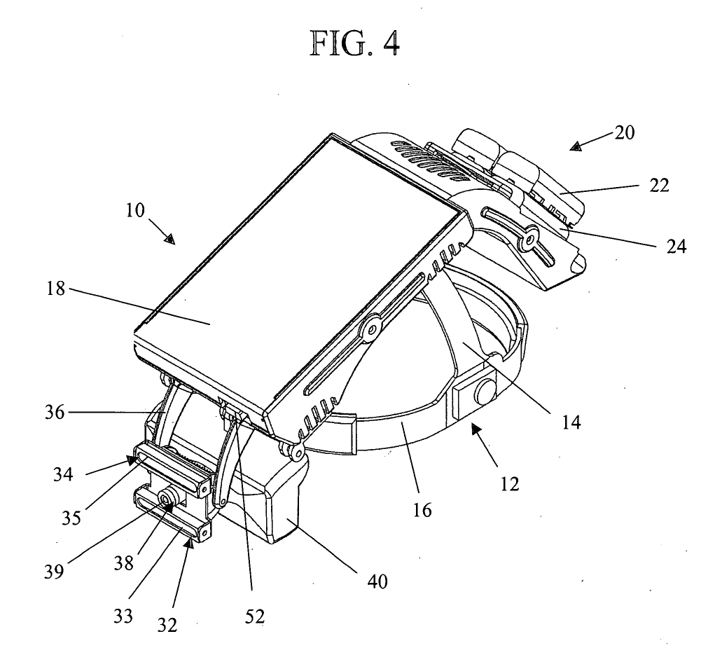

FIGS. 4 & 5 show the preferred embodiment of the image display system 10 of the present invention. The preferred embodiment of the system 10 includes a headset 12 to which all system components are attached. The preferred headset 12 includes two plastic bands 14, 16; a vertical band 14 connected to sides of a horizontal band 16. The vertical band 14, holding most of the system components, generally acts as a load-bearing member, while the horizontal band 16 is adjustable such that it snugly fits about the forehead of the person using the system.

A pivoting housing 18 is attached to the headband 12. The housing 18 is substantially hollow and is sized to house and protect a headset electronics unit (not shown) disposed therein. Attached to the housing 18 are a power supply 20, an image capture assembly 30, and an enhanced image display unit 40.

The power supply 20 for the headset electronics unit preferably includes two rechargeable lithium ion batteries 22, which are connected to the computing unit via a pair of battery terminals 24 attached to the rear of the housing 18. The rechargeable lithium ion batteries 22 are preferably of the same type commonly used with video camcorders, as these are readily available, are rechargeable without fear of memory problems, make the unit completely portable, and will provide sufficient power to the computing unit when two such batteries 22 are used. However, it is recognized that any power supply 20 known in the art to supply power to electronics, such as alternating current power plugs, may be employed to achieve similar results.

The image capture assembly 30 is powered thorough the headset electronics unit and includes a pair of infrared emitters 32, 34, and a camera 38 disposed between the infrared emitters 32, 34. The infrared emitters 32, 34 and camera 38 are preferably attached to a common mounting surface 31 and are pivotally connected to a pair of extension arms 36 that extend from the housing 18. Mounting in this manner is preferred as it allows the emitters 32, 34 and camera 38 to be aimed at the proper target, regardless of the height or posture of the person wearing the headset. However, it is recognized that both could be fixedly attached to the headset, provided the relationship between the emitters 32, 34 and camera 38 remained constant.

The infrared emitters 32, 34 of the preferred embodiment are surface mount LEDs (light emitting diodes) that feature a built-in micro reflector. Light emitting diodes are particularly convenient when positioned about the head because they are found to generate less heat then conventional bulbs and do not require frequent changing. Further, surface mount LED's that emit infrared light through light shaping diffusers provide uniform light and are readily adapted for attachment to a variety of other flat filter media. The preferred infrared emitters 32, 34 each utilize a row of such LED's in front of which is disposed a light shaping diffuser (not shown). Such emitters 32, 34 may be purchased from Phoenix Electric Co., Ltd., Torrance, Calif. First polarizing filters 33, 35 are mounted in front to the light shaping diffusers of each of the infrared emitters 32, 34. These polarizing filters 33, 35 are preferably flexible linear near-infrared polarizing filters, type HR, available from the 3M Corporation of St. Paul, Minn. In operation, the LED's are powered through the computing unit and emit infrared light, which passes through the light shaping diffuser and the first polarizing filters 33, 35 to produce the polarized infrared light that is directed upon the object to be viewed.

The camera 38 is adapted to capture the infrared light reflected off of the object to be viewed and to provide this “raw image data” to the computing unit. The preferred camera 38 is a monochrome CMOS camera that includes a high pass filter (not shown) that filters out all light outside of the infrared spectrum, including visible light. A CMOS camera is preferred as it produces pure digital video, rather than the analog video produced by the CCD cameras disclosed in the prior art, and is, therefore, not susceptible to losses, errors or time delays inherent in analog to digital conversion of the image. The CMOS camera is may be any number of such cameras available on the market, including the OMNIVISION™ model OV7120, 640×480 pixel CMOS camera, and the MOTOROLA® model XCM20014. In the test units, the OMNIVISION™ camera was used with good success. However, it is believed that the MOTOROLA® camera will be preferred in production due to its enhanced sensitivity to infrared light and the increased sharpness of the raw image produced thereby. A second linear polarizing filter 39 is disposed in front of the lens of the camera 38. This second polarizing filter 39 is positioned so as to be perpendicular to the direction of polarization through the first polarizing filters 33, 35 in front of the infrared emitters 32, 34, effectively cross polarizing the light detected by the camera 38 to reduce specular reflection. The polarizing filter 39 was selected for its high transmission of near-infrared light and high extinction of cross polarized glare. Such polarizer may be purchased from Meadowlark Optics, Inc. of Frederick, Colo. under the trademark VersaLight™.

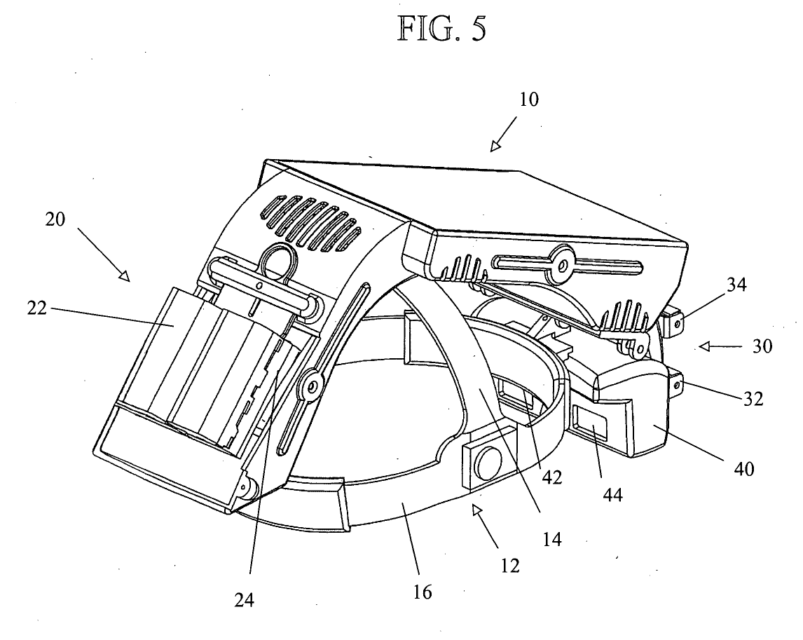

The camera 38 is in communication with the headset electronics unit and sends the raw image data to the unit for processing. The headset electronics unit includes the electronics required to supply power from the power supply 20 to the image capture assembly 30, and an enhanced image display unit 40, and the compatible processing unit (not shown) which accepts the raw image data from the camera 38, enhances the raw image, and sends an output of the enhanced image to the enhanced image display unit 40 and, optionally, to an output, such as the VGA output 52 shown in FIG. 5. The preferred processing unit is a digital media evaluation kit produced by ATEME, Ltd SA, Paris, France under model number DMEK6414, which uses a Texas Instruments TMS320C6414 digital signal processor. This processing unit is preferably programmed with the computer program product discussed above to perform the method that is likewise discussed above. However, it is understood that other systems may use different means for similarly enhancing such images in near real-time and, therefore, it is understood that all embodiments of the invention need not include this program product or perform the claimed method.

The enhanced image is outputted from the processing unit to the enhanced image display unit 40. The preferred display unit 40 is distributed by i-O Display Systems of Sacramento, Calif., under the trademark I-Glasses VGA. This display unit 40 includes a binocular display that includes a pair of LCD screens in front of which are disposed a pair of optical lenses 42, 44 that allow the focal length to be adjusted for ease of viewing. However, it is understood that a monocular display unit 40 having no such focal length adjustment could likewise be used. The preferred display unit 40 also includes an on-screen display that is not currently used, but may be used in the future to show what enhancement option has been chosen by the user.

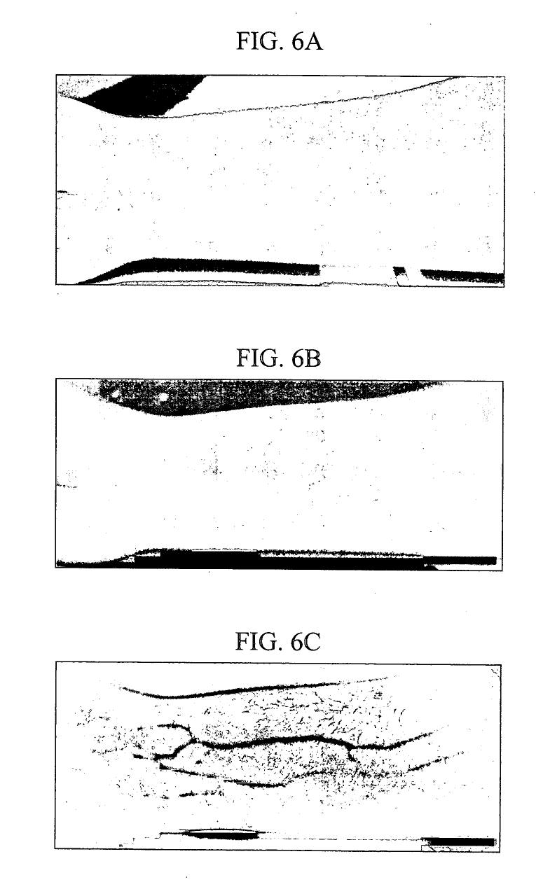

FIGS. 6A, 6B and 6C demonstrate the image enhancement produced by the system of the present invention. FIG. 6A is a photograph of a human forearm using light from the visible spectrum. As seen from this photograph, it is difficult to locate the veins upon visual inspection. FIG. 6B is a raw image of the same human forearm sent from the image capture assembly 30 of the present invention to the processing unit. The veins in this image is considerably more visible than those in FIG. 6A. However, they are not sufficiently dark and well defined to allow easy location of the veins during venepuncture. FIG. 6C is an enhanced image using the image enhancement process of the present invention. As can be seen from this figure, the veins are very dark and, therefore, are easily located for venepuncture.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

1. A process for enhancing blood vessel images within images of a region under skin of a part of a living body, said process comprising the steps of:
saving unenhanced image data representing the image of the region under the skin of the part of the living body;
copying said unenhanced image data to create a copy of said unenhanced image data;
transforming said copy of said unenhanced image data to produce transformed image data;
smoothing a substantial portion of said transformed image data to produce smoothed image data;
retransforming said smoothed image data;
inverting said retransformed smoothed image data to generate inverted image data,
wherein said inverted image data comprises enhanced images of blood vessels; and
adding at least a portion of said inverted image data to at least a portion of said saved unenhanced image data to generate a result image in which said enhanced images of blood vessels are shown within the image of the region under skin of the part of the living body.

2. The process of claim 1 wherein said smoothing step comprises the step of blurring said transformed image data to produce smoothed image data.

3. The process of claim 2 wherein said blurring step comprises Gaussian blurring said transformed image data, wherein said Gaussian blurring step comprises initializing a kernel and wherein said initializing step comprises the steps of:
generating an effectively-dimensioned kernel array;
padding said effectively-dimensioned kernel array to produce an effectively dimensioned padded kernel array; and
transforming said effectively padded kernel array.

4. The process of claim 3 wherein said step of generating an effectively dimensioned kernel comprises the step of generating a kernel having a base radius of approximately 51.

5. The process of claim 4 wherein said step of padding said effectively-dimensioned kernel array to produce an effectively-dimensioned padded kernel array comprises the step of padding said effectively-dimensioned kernel array to produce a kernel padded to a size with a height having a power of two and a width having a power of two.

6. The process of claim 5 wherein said step of padding said effectively-dimensioned kernel array to produce an effectively-dimensioned padded kernel array comprises the step of padding said effectively-dimensioned kernel array to produce a kernel padded with a black border to a size of 1024 by 512 pixels.

7. The process of claim 2 wherein said blurring step further comprises the step of frequency-convolving said transformed image data to produce smoothed image data.

8. The process of claim 1 further comprising the step of padding said copy of said unenhanced image data to produce padded image data, wherein said transforming step comprises transforming said padded image data to produce transformed image data.

9. The process of claim 1 further comprising the step of contrast stretching said result image to include a substantially full range of pixel values to generate a stretched image.

10. The process of claim 9 further comprising the step of applying an effective gamma curve to said stretched image to generate a gamma corrected image.

11. The process of claim 1 further comprising the step of applying an effective gamma curve to said result image to generate a gamma corrected image.

12. The process of claim 11 further comprising the step of padding said copy of said unenhanced image data to produce padded image data, wherein said transforming step comprises transforming said padded image data to produce transformed image data.

13. The process of claim 1 wherein said unenhanced image data is analog image data and wherein said process further comprises the step of converting said analog unenhanced image data to an effectively-dimensioned digital image array.

14. The process of claim 13 wherein said step of converting said analog unenhanced image data to an effectively-dimensioned digital image array comprises the step of converting said analog image to an 8-bit grayscale image array.

15. The process of claim 1 wherein said smoothing step comprises blurring a substantial portion of said transformed image data and wherein said blurring comprises the step of generating a blur kernel from a standard deviation determined to be effective for enhancing blood vessels.

16. The process of claim 15 wherein said blurring step comprises Gaussian blurring a substantial portion of said transformed image data and wherein said Gaussian blurring comprises the step of generating a Gaussian blur kernel from a standard deviation in the range of between about 10 pixels and 23 pixels.

17. The process of claim 1 further comprising the steps of repeating said saving, transforming, smoothing, retransforming, inverting, and adding steps at a rate sufficient to produce a sequence of result images in substantially real time.

18. The process of claim 17 wherein said repeating step comprises repeating said saving, transforming, smoothing, retransforming, inverting, and adding steps at a rate of at least five times per second.

19. The process of claim 1 further comprising the step of selecting a ratio of said inverted image data to be added to said saved unenhanced image data to generate said result image, wherein said selecting step is performed prior to performing said adding step.

20. A computer program product for enhancing blood vessel images within images of a region under skin of a part of a living body, said computer program product comprising:
program means for creating a copy of saved unenhanced image data corresponding to said image of the region under skin of the part of the living body;
a digital transformer for transforming said copy of said saved unenhanced image data to produce transformed image data;
a smoothing operator for smoothing a substantial portion of said transformed image data to produce smoothed image data;
a retransformer for retransforming said smoothed image data;
a digital inverter for inverting said retransformed smoothed image data to generate inverted image data, wherein said inverted image data comprises enhanced images of blood vessels; and
an adding function for adding at least a portion of said inverted image data to at least a portion of said unenhanced image data to generate a result image in which said enhanced images of blood vessels are shown within the image of the region under the skin of the part of the living body.

21. The computer program product of claim 20 wherein said smoothing operator comprises blurring means.

22. The computer program product of claim 21 wherein said blurring means comprises 2-D Gaussian-blurring means comprising:
a kernel generator for generating an effectively-dimensioned kernel array;
a kernel padding operator for padding said effectively-dimensioned kernel array to produce an effectively-dimensioned padded kernel array; and
a kernel transforming operator for transforming said effectively padded kernel array.

23. The computer program product of claim 22 wherein said kernel generator generates a kernel having a base radius of approximately 51.

24. The computer program product of claim 22 wherein said effectively-dimensioned padded kernel array is padded to a size with a height having a power of two and a width having a power of two.

25. The computer program product of claim 24 wherein said effectively-dimensioned padded kernel array is padded with a black border to a size of 1024 by 512 pixels.

26. The computer program product of claim 21 wherein said blurring means comprises frequency convolving means.

27. The computer program product of claim 20 further comprising padding means for padding image data to produce padded image data, and wherein said digital transformer transforms said padded image data to produce transformed image data.

28. The computer program product of claim 20 further comprising a contrast stretcher for stretching said result image to include a substantially full range of pixel values to generate a stretched image.

29. The computer program product of claim 28 further comprising gamma correction means for generating a gamma corrected image from said stretched image.

30. The computer program product of claim 20 further comprising gamma correction means for generating a gamma corrected image from said result image

31. The computer program product of claim 20 wherein said smoothing operator comprises blurring means for blurring a substantial portion of said transformed image data and wherein said blurring means comprises the means for generating a blur kernel from a standard deviation determined to be effective for enhancing blood vessel images

32. The computer program product of claim 31 wherein said blurring means comprises Gaussian blurring means and wherein said means for generating a blur kernel comprises means for generating a Gaussian blur kernel from a standard deviation in the range of between about 10 pixels and 23 pixels.

33. The computer program product of claim 20 further comprising means for outputting a sequence of result images in substantially real time.

34. The computer program product of claim 33 wherein said means for outputting a sequence of result images outputs result images at a rate of at least five result images per second.

35. The computer program product of claim 33, wherein said adding function further comprises a ratio selector for selecting a ratio of said inverted image data to be added to said saved unenhanced image data in order to generate said result image.

36. An image enhancement and display system for enhancing blood vessel images within images of a region under skin of a part of a living body, said system comprising:
a computing unit having a memory and a signal input for accepting a signal corresponding to unenhanced image data and saving said unenhanced image data into said memory;
a computer program product stored in said memory and executable by said computing unit, said computer program product comprising:
program means for creating a copy of said unenhanced image data stored in memory;
a digital transformer for transforming image data to produce transformed image data;
a smoothing operator for smoothing a substantial portion of said transformed image data to produce smoothed image data;
a retransformer for retransforming said smoothed image data;
a digital inverter for inverting said retransformed smoothed image data to generate inverted image data, said wherein said inverted image data comprises enhanced images of blood vessels;
an adding function for adding at least a portion of said inverted image data to at least a portion of said unenhanced image data to generate result image data in which said enhanced images of blood vessels are shown within the image of the region under the skin of the part of the living body; and
output means for outputting said result image data;
first transmitting means for accepting said result image data from said output means and transmitting a signal corresponding to said result image data; and
a display device adapted to accept said signal from said transmitting means and to display a result image based upon said accepted signal.

37. The system of claim 36 further comprising a headset comprising said display device.

38. The system of claim 37 wherein said headset further comprises said computing unit and said transmitting means.

39. The system of claim 36 wherein said display device is a computer monitor

40. The system of claim 36 further comprising a detection assembly comprising:
an infrared emitter configured to illuminate the region under the skin of the part of the living body; and
an infrared detector in communication with said signal input of said computing unit, said infrared detector being adapted to detect infrared emissions reflected from said region under the skin, create unenhanced image data from said detected infrared emissions, generate said signal corresponding to unenhanced image data, and to send said signal to said signal input of said computing unit.

41. The system of claim 40 wherein said infrared detector is a CMOS receptor adapted to generate said signal corresponding to unenhanced digital image data.

42. The system of claim 36 further comprising a second transmitting means for accepting said result image data from said output means and transmitting a second signal corresponding to said result image data.

43. The system of claim 36 wherein said computer program product is adapted to be executed sequentially such that said output means outputs a sequence of result images in substantially real time.

44. The system of claim 46 wherein said output means outputs a sequence of result images at a rate of at least five times per second.

45. A system for capturing images of a region under skin of a part of a living body, enhancing blood vessel images within captured images, and displaying enhanced result images in substantially real time, said system comprising:
an infrared emitter configured to illuminate the region under the skin with waves of infrared fight;
an infrared detector configured to accept waves of infrared light reflected from the region under the skin, said infrared detector comprising an output for outputting a signal corresponding to unenhanced image data;
a computing unit comprising an input for accepting said unenhanced image data, a memory, means for enhancing and outputting result images in which enhanced images of blood vessels are shown within the images of the region under the skin of the part of the living body, and an output for outputting said enhanced images; and
a display device for inputting said enhanced images from output of said computing unit and displaying said enhanced images in substantially real time.

46. The system of claim 45 wherein said means for enhancing and outputting result images outputs said result images at a rate of at least five images per second.

47. The system of claim 45 wherein said infrared emitter comprises two arrays of surface mounted light emitting diodes comprising integral micro reflectors.

48. The system of claim 47 wherein said infrared detector is a CMOS receptor adapted to generate digital data corresponding to skin-reflected infrared wave reception.

49. The system of claim 45 wherein said infrared detector is a CMOS receptor adapted to generate digital data corresponding to skin-reflected infrared wave reception.

50. The system of claim 45 wherein said computer program means comprises:
a digital transformer means for transforming image data to produce transformed image data;
a smoothing operator for smoothing a substantial portion of said transformed image data to produce smoothed image data;
a digital retransforming means for retransforming said smoothed image data
a digital inverter for inverting said smoothed image data to generate inverted image data; and
an adding function for adding said inverted smoothed image data to unenhanced image data to generate a result image.

51. The system of claim 45 further comprising a headset and at least one battery in electrical communication with said computer unit, and wherein said display device, said computing unit, and said at least one battery are attached to said headset.

52. The system of claim 51 wherein said infrared emitter and said infrared detector to said headset.
